(19) United States
(12) Patent Application Publication
(10) Pub. No.: US 2025/0316735 A1
(43) Pub. Date: Oct. 9, 2025

(54) ANION CONDUCTING POLYMER ELECTROLYTE MEMBRANES BY ULTRAVIOLET-LIGHT CURING FOR QUASI-SOLID-STATE ZINC-AIR BATTERIES

(71) Applicant: COUNCIL OF SCIENTIFIC AND INDUSTRIAL RESEARCH, New Delhi (IN)

(72) Inventors: Vidyanand VIJAYAKUMAR, Pune (IN); Maria KURIAN, Pune (IN); Sreekumar KURUNGOT, Pune (IN)

(21) Appl. No.: 18/836,322

(22) PCT Filed: Feb. 7, 2023
(86) PCT No.: PCT/IN2023/050122

§ 371 Date: Aug. 6, 2024

(30) Foreign Application Priority Data
Feb. 7, 2022 (IN) 202211006594

(51) Int. Cl. H01M 8/1025; H01M 4/86; H01M 4/90; H01M 8/10; H01M 8/106; H01M 8/1072; H01M 8/1088; H01M 12/06; H01M 50/109

(52) U.S. Cl. CPC H01M 8/1025; H01M 4/9041; H01M 8/106; H01M 8/1072; H01M 8/1088; H01M 12/06; H01M 50/109; H01M 2004/8684; H01M 2008/1095

(57) ABSTRACT

The current invention describes Anion exchange polymer electrolyte membrane (AEPEM) by simple UV-irradiation procedure using simple acrylate/methacrylate monomers/oligomers, with at least one of them possessing quaternary ammonium group to obtain a polymer membrane, which when soaked in 6 M KOH solution yield an AEPEM having OH— group incorporated into the polymer matrix having good ionic conductivity.

### FIELD OF INVENTION

The current invention is in field of polymer electrolyte membranes for zinc-air batteries. More particularly, the present invention relates to a method for synthesis of an anion exchange polymer electrolyte membrane by simple UV-irradiation procedure.

### BACKGROUND OF INVENTION

Conventionally, porous polymer membranes (e.g., polypropylene) wetted by liquid electrolytes, such as an aqueous solution of 6 M KOH are used as a separator in zinc-air batteries (ZABs). Similarly, glass fibre paper is also often employed as separator for ZAB application. The role of these polymer membranes/glass fiber papers is to mechanically separate the anode and cathode compartments from coming into contact with each other but often do not contribute to the ion conduction, hence remain a dead-weight. Besides, the direct use of high pH liquid electrolytes as such 6 M KOH solution in ZABs incite accelerated corrosion of Zn-anode, dendritic growth of Zn, and several other safety concerns such as the risk of electrolyte leakage, which results in inferior cycling stability eventually leading to cell-failure. Further, KOH reacts with CO₂ leading to carbonate precipitation and this result in decrease of the electrolyte concentration. Furthermore, the carbonate blocks the pore which further decreases the efficacy of the battery. Also, water leakage from electrolyte and the oxygen bubbles associated with the reactions decrease the performance of the battery.

To tackle these issues and to improve the prospects of flexibility in ZABs, anion exchange polymer electrolyte membranes (AEPEMs) is inevitable. Compared to liquid electrolytes possessing ion conduction evolved from both cations and anions, AEPEMs can assist selective conduction of OH ions. Being a mechanically stable and self-standing polymer membrane with liquid electrolyte/OH groups encapsulated within, AEPEMs can improve flexibility and safety prospects when used in ZABs. Moreover, unlike the neutral polymeric/glass fiber separator, the charged polymer host in an AEPEM inherently contributes to ion conduction, minimizing the dead-weight evolved from an otherwise non-ion-conducting separator.

Conventionally, the preparation of AEPEMs is carried out by top-down approaches involving tedious and multiple synthetic steps.

Yang et al., Journal of Membrane Science, 2014, 467, 48-55 prepared an AEPEM based on imidazolium salt. This membrane preparation involved synthesizing a polymer host poly (arylene ether sulfone) containing pendent imidazolium groups from 2-ethyl-4-methylimidazole by the multi-step process, which was then treated with n-bromobutane in dimethylacetamide followed by casting to obtain a polymer membrane. The obtained membrane is converted to OH form by treating with 1M NaOH solution for 48 hrs to obtain an AEPEM exhibiting ionic conductivity around 14 m S cm-1.

Wei et al., ACS Applied Materials & Interfaces, 2018, 10, 29593-29598 developed an OH-conducting AEMs membrane by cross-linking chitosan (CS) and poly(diallyl dimethylammonium chloride) (PDDA) composites possessing an ionic conductivity of 24 m S cm⁻¹ by simple polymer blending method.

Fu et al., Energy & Environmental Science, 2016, 9, 663-670 prepared an anion conducting polymer electrolyte membrane based on functionalized cellulose nanofibres, which involved the cellulose extraction from Softwood Kraft pulp followed by functionalization with quaternary ammonium group giving a membrane of ionic conductivity of about 21.2 m S cm-1.

Zhang et al., Advanced Energy Materials, 2016, 6, 1600476 developed a hydroxide ion-conducting polymer electrolyte membrane with a laminated structure based on functionalized graphene oxide and nanocellulose, having ionic conductivity around 39 m S cm-1. The preparation of this composite electrolyte involved tedious multi-step processes like GO synthesis, nano cellulose extraction followed by functionalization with the quaternary ammonium groups.

Lin et al., ChemSusChem, 2018, 11, 3215-3224 prepared polyvinyl alcohol-based anion conducting polymer electrolyte membrane by introducing quaternary ammonium groups processing an ionic conductivity as high as 46.8 m S cm⁻¹ by laborious blending method. However, the methods as listed herein before are tedious and involves multiple synthetic steps. Therefore, in view of above, the current inventors proposed a novel, economical method for synthesis of anion exchange polymer electrolyte membranes (AEPEMs).

### Objectives of Invention

An important object of the present invention is to provide a polymer electrolyte membrane for quasi-solid-state zinc-air batteries (ZABs).

Another object of the present invention is to provide process for the preparation of polymer electrolyte membranes for quasi-solid-state Zinc-air batteries.

A yet another object of the present invention is to provide an economical method for synthesis of anion exchange polymer electrolyte membranes (AEPEMs).

A yet another object of the present invention is to introduce the concept of in-situ polymerization for the enhancement of electrode/electrolyte interface in quasi-solid-state zinc-air battery.

### SUMMARY OF INVENTION

In an aspect, the present invention provides a simple economical method for the synthesis of anion exchange polymer electrolyte membranes (AEPEMs) from a polymer membrane referred to as AHM.

The invention further provides anion exchange polymer electrolyte membranes (AEPEMs) synthesized by the process of invention and the batteries containing said membranes.

In an aspect the present invention relates to a process for preparing an anion exchange polymer electrolyte membrane AEPEM and AEPEM-GF, comprising the steps of:
a) Preparing a reactive solution comprising a 2-[(Acryloyloxy) ethyl] trimethylammonium chloride solution (AOETMA), a hydroxy ethyl methacrylate (HEMA), a poly (ethylene glycol) methyl ether methacrylate (PEGMEMA), and a acrylate/methacrylate monomer/oligomer crosslinker;
b) adding 2-Hydroxy-2-methylpropiophenone or free-radical polymerization initiator in the reaction solution of step a) as a photo-initiator;
c) optionally soaking a glass fiber paper (GF) in the reactive solution of step b);
d) casting the reactive solution of step b) or placing GF soaked in reactive solution of step
c) between two polyethylene terephthalate films;
e) subjecting the above-casted films to a UV-curing to give a cationic (or positively charged) polymer membrane (AHM) or cationic (or positively charged) glass fiber polymer membrane (AHM-GF); and
f) treating polymer membranes of step e) with KOH solution to form a OH doped anion exchange polymer electrolyte membranes (AEPEMs) or OH⁻ doped glass fiber anion exchange polymer electrolyte membrane (AEPEM-GF);
   wherein, at least one of the monomer is having quaternary ammonium salt. (see, FIGS. 1-4 and 9).

In yet another aspect, all steps a) to f) including optional step c) are done at temperature in the range of 20-30° C., and without the need of solvent.

In another aspect, the present invention relates to a battery comprising an anion exchange polymer electrolyte membrane as disclosed herein.

In another aspect, the present invention relates to zinc-air battery comprising:
i. a Pt/C-RuO₂ or Pt/C air-cathode or in-situ polymerized Pt/C-RuO₂ or Pt/C air-cathode;
ii. an anion exchange polymer electrolyte membrane (AEPEM) or glass fiber anion exchange polymer electrolyte membrane (AEPEM-GFs);
iii. a zinc anode; and
iv. a metallic casing. (see, FIG. 1 or 4)

In yet another aspect, the metallic casing of the battery comprises base, spacer, and spring in a coin-cell configuration.

In yet another aspect, the membrane of battery showed a stretchability of up to 68 to 70% and tensile stress ranging in about 280 to 290 kPa (refer, FIG. 16).

In another aspect, the present invention provides an in-situ polymerized Pt/C or Pt/C-RuO₂ air-cathode, that improves an electrode-electrolyte contact in quasi-solid-state zinc-air batteries which is prepared by steps comprising of;
a) brush coating the reactive solution comprising a 2-[(Acryloyloxy) ethyl] trimethylammonium chloride solution (AOETMA), a hydroxy ethyl methacrylate (HEMA), a poly (ethylene glycol) methyl ether methacrylate (PEGMEMA), and a acrylate/methacrylate monomer/oligomer crosslinker;
b) subjecting the polymer-coated air cathode to UV polymerization to obtain AHM skin over the cathode surface; and
c) contacting the AHM polymer skin with KOH solution from the AEPEM or AEPEM-GF membrane while device fabrication, subsequently turning the AHM skin to the AEPEM-skin. (refer, FIGS. 4 and 9)

In yet another aspect, the AEPEM-GF composite electrolyte membrane in combination with the in-situ polymerized Pt/C or Pt/C-RuO₂ air-cathode improves an electrode-electrolyte contact in quasi-solid-state zinc-air batteries.

In another aspect, the present invention further provides a flexible and rechargeable zinc-air battery, comprising:
a) an anode made up of thin Zinc foil of 0.1 mm thickness;
b) cathode having a Pt/C-RuO₂ coated carbon cloth with a thin layer of in-situ polymerized polymer skin from a precursor solution comprising a 2-[(Acryloyloxy) ethyl] trimethylammonium chloride solution (AOETMA), a hydroxy ethyl methacrylate (HEMA), a poly (ethylene glycol) methyl ether methacrylate (PEGMEMA), and a acrylate/methacrylate monomer/oligomer crosslinker; and
c) an AEPEM or AEPEM-GF membrane as the quasi-solid-state electrolyte;
   wherein the AEPEM or AEPEM-GF membrane is sandwiched between the modified carbon cloth and Zinc foil. (refer, FIGS. 1-4, 9, 19 and 20)

In another aspect, the reactive solution is comprising of 2-(Acryloyloxy) ethyl] trimethylammonium chloride solution (AOETMA), hydroxy ethyl methacrylate (HEMA), poly (ethylene glycol) methyl ether methacrylate (PEGMEMA), and poly (ethylene glycol) diacrylate (PEGDA).

In yet another aspect, the reactive solution is comprising of 1 to 1.8 wt % of 2-(Acryloyloxy) ethyl] trimethylammonium chloride solution (AOETMA), 4 to 7.2 wt % of hydroxy ethyl methacrylate (HEMA), 1 to 5 wt % poly (ethylene glycol) methyl ether methacrylate (PEGMEMA), and 1 wt % poly (ethylene glycol) diacrylate (PEGDA).

In yet another aspect, the reactive solution is comprising 1.2 to 1.6 wt % 2-(Acryloyloxy) ethyl] trimethylammonium chloride solution (AOETMA), 5.4 to 5.8 wt % hydroxy ethyl methacrylate (HEMA), 2.8 to 3.2 wt % poly (ethylene glycol) methyl ether methacrylate (PEGMEMA), and 1 wt % poly (ethylene glycol) diacrylate (PEGDA).

In yet another aspect, the monomer/oligomer as disclosed in step a) is selected from a poly (ethylene glycol) based monomers or oligomers, preferably the monomer/polymer is poly (ethylene glycol) based derivatives.

In a particular embodiment, the present invention relates to a battery comprising an anion exchange polymer electrolyte membrane (AEPEM).

### BRIEF DESCRIPTION OF DRAWINGS

FIG. 1 illustrates schematic representation of the process of invention.

FIG. 2 illustrates the photograph of the AEPEM membrane manufactured by the process of invention.

FIG. 3 illustrates Schematic representation of AEPEMs.

FIG. 4 illustrates the schematic representation of the Zinc-Air Battery using the AEPEM manufactured by the process of invention.

FIG. 5 illustrate Ionic conductivity vs. temperature plot associated with the AEPEM membranes based on AHM 70:30, AHM 50:50 and AHM 90:10.

FIG. 6 illustrates swelling studies of AHM 50:50, AHM 70:30 and AHM 90:10 polymer membranes.

FIG. 7 illustrates electrolyte retention study of AHM 70:30 polymer membrane and a commercial counterpart.

FIG. 8 illustrates Stress vs. strain plots associated with the AEPEM based on AHM 70:30 membrane.

FIG. 9 illustrates schematic diagrams showing (a) in situ polymerization process over the air cathode; (b) comparison of electrode|electrolyte interface in the quasi-solid-state zinc-air battery (ZAB) with and without in situ polymerization.

FIG. 10 illustrates a schematic representation of AEPEM-GF membrane.

FIG. 11 illustrates specific capacity plot for the Pt/C air-cathode-based ZAB using AEPEM membrane with (AEPEM ZAB with in-situ) and without (AEPEM ZAB without in-situ) in situ polymerization approach.

FIG. 12 illustrates comparison of electrochemical impedance spectroscopy (EIS) plots of Pt/C air cathode-based ZAB using AEPEM membrane with (AEPEM ZAB with in-situ) and without (AEPEM ZAB without in-situ) in situ polymerization approach.

FIG. 13 illustrates Specific capacity plot for AEPEM-GF composite electrolyte membrane-based ZAB with (AEPEM-GF ZAB with in-situ) and without (AEPEM-GF ZAB with in-situ) in situ polymerization approach.

FIG. 14 illustrates Comparison of EIS data for AEPEM ZAB with in-situ and AEPEM-GF ZAB without in-situ cells.

FIG. 15 illustrates Ionic conductivity vs. temperature plot associated with the AEPEM-GF composite electrolyte membranes.

FIG. 16 illustrates Stress versus strain plots associated with the AEPEM-GF membrane.

FIG. 17 illustrates the polarization plots for rechargeable zinc-air battery (rZAB) without in-situ and with in-situ process using state of the art Pt/C-RuO₂ catalyst coated gas diffusion layer (GDL) substrate as air-cathode.

FIG. 18 illustrates the long-time charge-discharge plots rechargeable zinc-air battery (rZAB) with (rZAB with in-situ) and without (rZAB without in-situ) in-situ process using state of the art Pt/C-RuO₂ catalyst coated GDL substrate as air-cathode.

FIG. 19 illustrates the polarization plots for flexible rechargeable ZAB (F-rZAB) system.

FIG. 20 illustrates the long-time charge-discharge plots for F-rZAB.

### DETAILED DESCRIPTION OF THE INVENTION

AHM used herein can be referred as: A as AOETMA, Has HEMA, and M as PEGMEMA. Described herein is a process for preparing an anion exchange polymer electrolyte membranes (AEPEMs) using simple acrylate/methacrylate monomers/oligomers followed by simple UV-irradiation process to obtain a cross-linked polymer, which is then soaked in 6 M KOH solution which gives a polymer electrolyte that can replace liquid electrolytes in rechargeable zinc-air batteries (ZABs).

Accordingly, the method of invention uses monomer containing quaternary ammonium salt that undergoes free radical polymerization with acrylate/methacrylate monomers/oligomers in single step process, thus yielding cross-linked polymer containing positively charged functional moieties (anion exchange moieties). The as-prepared positively charged polymer membranes are capable of OH incorporation when soaked in 6 M KOH solution, making it capable of OH conduction with ionic conductivity value of around 32.5 m S cm-1 at 30° C. The prepared membranes are found to possess high mechanical and chemical stability both in the KOH swollen and unswollen states. Also, the membranes of the invention exhibit air stability with possible preservation under ambient conditions.

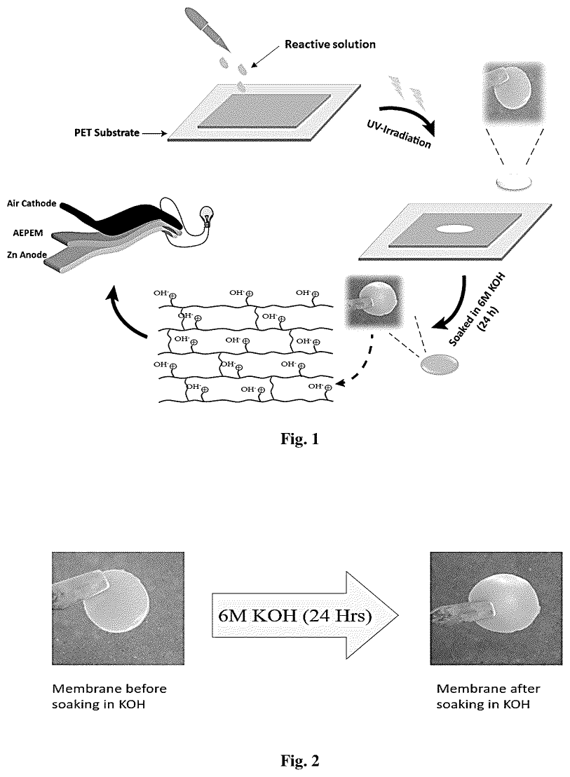

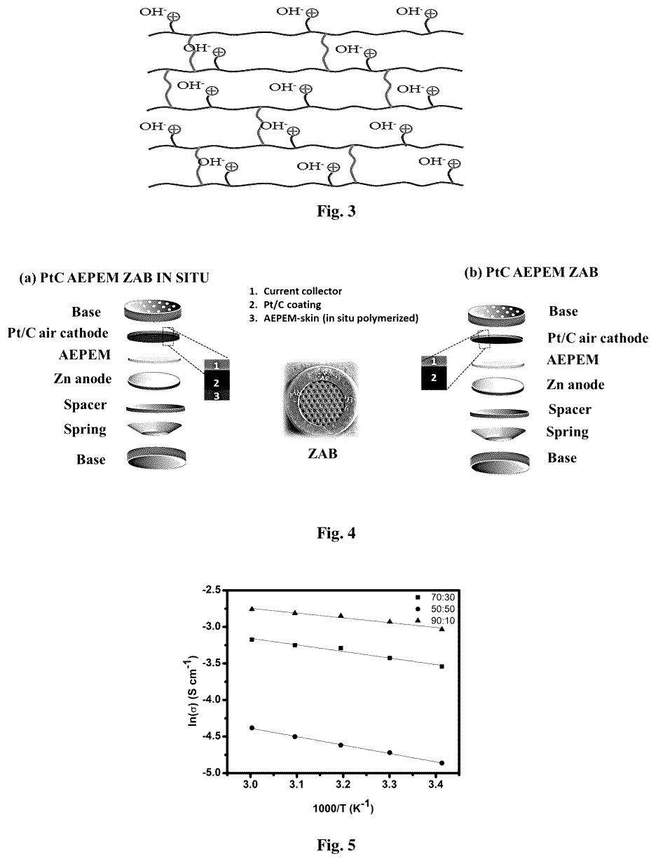

In an embodiment, the present invention relates to a process for preparing an anion exchange polymer electrolyte membrane (AEPEM), comprising the steps of:
a) preparing a reactive solution comprising a 2-[(Acryloyloxy) ethyl] trimethylammonium chloride solution (AOETMA), a hydroxy ethyl methacrylate (HEMA), a poly (ethylene glycol) methyl ether methacrylate (PEGMEMA), and a acrylate/methacrylate monomer/oligomer crosslinker;
b) adding a 2-Hydroxy-2-methylpropiophenone or free-radical polymerization initiator in the reaction solution of step a) as a photo-initiator;
c) optionally soaking a glass fiber paper (GF) in the reactive solution of step b);
d) casting the reactive solution of step b) or placing GF soaked in reactive solution of step
c) between two polyethylene terephthalate films.
e) subjecting the above-casted films to a UV-curing to give a cationic (or positively charged) polymer membrane (AHM) or cationic (or positively charged) glass fiber polymer membrane (AHM-GF); and
f) treating polymer membrane of step e) with KOH solution to form a OH doped anion exchange polymer electrolyte membranes (AEPEMs) or OH doped glass fiber anion exchange polymer electrolyte membrane (AEPEM-GF);
   wherein, at least one of the monomer is having quaternary ammonium salt. (see, FIGS. 1-4 and 9)

In another embodiment, all steps a) to f) including optional step c) are done at temperature in the range of 20-30° C., and without the need of solvent.

In another embodiment, the method of the invention uses a reactive solution (also called precursor solution) comprising of 2 (Acryloyloxy) ethyl] trimethylammonium chloride solution (AOETMA) (1 to 1.8 wt %), hydroxy ethyl methacrylate (HEMA) (4 to 7.2 wt %), poly (ethylene glycol) methyl ether-methacrylate (PEGMEMA) (5 to 1 wt %), and poly (ethylene glycol) diacrylate (PEGDA) (1 wt %) as the monomers/oligomers, which contributes to the mechanical stability of the polymer electrolyte membranes on UV-curing. 2-Hydroxy-2-methylpropiophenone (HMPP) (or 1-Hydroxy-cyclohexylphenylketone as an alternate) (1 wt %) is used as the photo-initiator. Approximately 0.5 mL of reactive mixture in the liquid state of desired ratio (50:50, 70:30, 90:10) is cast between two polyethylene terephthalate (PET) Films and on subjecting to UV-curing for 15-20 mins undergoes cross-linking polymerization to give polymer electrolyte membranes with solid-like operability and dimensional stability. Stable membranes of varying composition were obtained by changing the concentration of monomers and fixing the composition of cross linker and initiator at 1 wt %. The membranes hence formed are treated with 6 M KOH solution for 24 to 28 hrs to form OH doped polymer membranes which are referred to as anion exchange polymer electrolyte membranes (AEPEMs).

In another embodiment, the present invention provides a process for preparing glass fiber anion exchange polymer electrolyte membranes (AEPEM-GFs), comprising the steps of:
a) preparing a reactive solution comprising a 2-[(Acryloyloxy) ethyl] trimethylammonium chloride solution (AOETMA), a hydroxy ethyl methacrylate (HEMA), a poly (ethylene glycol) methyl ether methacrylate (PEGMEMA), and a acrylate/methacrylate monomer/oligomer crosslinker;
b) adding a 2-Hydroxy-2-methylpropiophenone or free-radical polymerization initiator in the reaction solution of step a) as a photo-initiator;
c) soaking a glass fiber paper (GF) in the reactive solution of step b);
d) casting the reactive solution of step b) or placing GF soaked in reactive solution of step
c) between two polyethylene terephthalate films.
e) subjecting the above-casted films to a UV-curing to give a cationic (or positively charged) polymer electrolyte membrane (AHM) or cationic (or positively charged) glass fiber polymer electrolyte membrane (AHM-GF); and
f) treating polymer electrolyte membrane of step e) with KOH solution to form OH doped glass fiber anion exchange polymer electrolyte membrane (AEPEM-GF);
   wherein, at least one of the monomer is having quaternary ammonium salt. (see, FIGS. 1-4 and 9).

The process of preparation of reactive solution (AHM 70:30) involves the following steps.
taking 1.4 wt % of AOETMA in a vial.
adding 5.6 wt % of HEMA to the above solution at room temperature and shaking in a vortex stirrer for 3-5 mins.
adding 3 wt % of PEGMEMA to above mixture followed by shaking again for 3 to 5 mins.
adding 1 wt % of PEGDA to the above solution and mixing well.
Finally, adding 1 wt % of the HMPP initiator to the above solution prior to the UV polymerization.

For preparation of AHM 70:30 about 500 μL of above reactive solution is casted between two PET Films and on subjecting to UV-curing for 15 mins, undergoes cross-linking polymerization to give polymer electrolyte membranes. Further, to obtain the anion exchange polymer electrolyte membrane the above obtained membrane is soaked in 6 M KOH for about 24 hrs to convert it into OH⁻ conducting form.

Similarly, AHM 50:50 and AHM 90:10 membranes were prepared as per the compositions given in table 1.

TABLE 1

| | Ratio of | Rato of | Ratio of |
|---|---|---|---|
| Sample name | AOETMA (A) | HEMA (H) | PEGMEMA (M) |
| AHM 90:10 | 1.8 | 7.2 | 1 |
| AHM 70:30 | 1.4 | 5.6 | 3 |
| AHM 50:50 | 1 | 4 | 5 |

In another embodiment, the present invention relates to a battery comprising an anion exchange polymer electrolyte membrane as disclosed herein.

In another embodiment, the present invention relates to zinc-air battery comprising:
v. a Pt/C or Pt/C-RuO₂ air-cathode or in-situ polymerized Pt/C or Pt/C-RuO₂ air-cathode;
vi. an anion exchange polymer electrolyte membrane (AEPEM) or glass fiber anion exchange polymer electrolyte membrane (AEPEM-GFs);
vii. a zinc anode; and
viii. a metallic casing. (see, FIG. 1 or FIG. 4)

In yet another embodiment, the metallic casing of the battery comprises base, spacer, and spring in a coin-cell configuration.

In yet another embodiment, the membrane of battery showed a stretchability of up to 68 to 70% and tensile stress ranging in about 280 to 290 kPa (refer, FIG. 16).

In another embodiment, the present invention provides an in-situ polymerized Pt/C or Pt/C-RuO₂ air-cathode, which is prepared by steps comprising of;
a) brush coating the reactive solution comprising a 2-[(Acryloyloxy) ethyl] trimethylammonium chloride solution (AOETMA), a hydroxy ethyl methacrylate (HEMA), a poly (ethylene glycol) methyl ether methacrylate (PEGMEMA), and a acrylate/methacrylate monomer/oligomer crosslinker;
b) subjecting the polymer-coated air-cathode to UV polymerization to obtain AHM skin over the cathode surface; and
c) contacting the polymer skin with KOH solution from the AEPEM-GF membrane while device fabrication, subsequently turning the AHM skin to the AEPEM-skin or AEPEM-GF skin. (refer, FIGS. 4 and 9)

In yet another embodiment, the AEPEM-GF composite electrolyte membrane in combination with the in-situ polymerized Pt/C or Pt/C-RuO₂ air cathode improves an electrode-electrolyte contact in Zinc-air batteries.

In another embodiment, the present invention further provides zinc-air battery, comprising:
d) an anode made up of thin Zinc foil of 0.1 mm thickness;
e) cathode having a Pt/C-RuO₂ coated carbon cloth with a thin layer of in-situ polymerized polymer skin from a precursor solution comprising a 2-[(Acryloyloxy) ethyl] trimethylammonium chloride solution (AOETMA), a hydroxy ethyl methacrylate (HEMA), a poly (ethylene glycol) methyl ether methacrylate (PEGMEMA), and an acrylate/methacrylate monomer/oligomer crosslinker; and
f) an AEPEM or AEPEM-GF membrane as the quasi-solid-state electrolyte; wherein the AEPEM or AEPEM-GF membrane is sandwiched between the modified carbon cloth and zinc foil. (refer, FIGS. 1-4, 9, 19 and 20)

In yet another embodiment, the reactive solution comprising of 2-(Acryloyloxy) ethyl] trimethylammonium chloride solution (AOETMA), hydroxy ethyl methacrylate (HEMA), poly (ethylene glycol) methyl ether methacrylate (PEGMEMA), and poly (ethylene glycol) diacrylate (PEGDA).

In yet another embodiment, the reactive solution comprising of 1 to 1.8 wt % of 2-(Acryloyloxy) ethyl] trimethylammonium chloride solution (AOETMA), 4 to 7.2 wt % of hydroxy ethyl methacrylate (HEMA), 1 to 5 wt % poly (ethylene glycol) methyl ether methacrylate (PEGMEMA), and 1 wt % poly (ethylene glycol) diacrylate (PEGDA).

In yet another embodiment, the reactive solution comprising 1.2 to 1.6 wt % 2-(Acryloyloxy) ethyl] trimethylammonium chloride solution (AOETMA), 5.4 to 5.8 wt % hydroxy ethyl methacrylate (HEMA), 2.8 to 3.2 wt % poly (ethylene glycol) methyl ether methacrylate (PEGMEMA), and 1 wt % poly (ethylene glycol) diacrylate (PEGDA).

In yet another embodiment, the monomer/oligomer as disclosed in step a) is selected from a poly (ethylene glycol) based monomers or oligomers, preferably the monomer/polymer is poly (ethylene glycol) based derivatives.

In yet another embodiment, the present invention further provides an in-situ polymerized zinc-air battery comprising of:
(i) an in-situ polymerized Pt/C or Pt/C-RuO₂ air-cathode;
(ii) the anion exchange polymer electrolyte membrane (AEPEM);
(iii) zinc anode; and
(iv) a metallic casing.

In yet another embodiment, the present invention further provides in-situ polymerized rechargeable zinc-air battery comprising:
(i) an in-situ polymerized Pt/C or Pt/C-RuO₂ air-cathode;
(ii) the glass fiber anion exchange polymer electrolyte membrane (AEPEM-GF);
(iii) zinc anode; and
(iv) metallic casing.

In yet another embodiment, the present invention further provides an in-situ polymerized flexible rechargeable zinc-air battery comprising:
(i) In-situ polymerized Pt/C-RuO₂ air-cathode;
(ii) the glass fiber anion exchange polymer electrolyte membrane (AEPEM-GF);
(iii) Zinc anode; and
(iv) metallic casing.

The membranes formed by the method of the invention were further subjected to conductivity and swelling studies. The membranes were further subjected to mechanical strength studies and electrolyte retention studies.

In another embodiment, the invention further provides a method for manufacturing of AEPEM-GF Composite membranes. Accordingly, the method involves soaking of the glass fiber paper in the reactive solution followed by UV-assisted free radical polymerization. The prepared AEPEM/glass fiber (AEPEM-GF) composite is further soaked in 6 M KOH solution to give the AEPEM-GF composite electrolyte membrane.

Accordingly, to prepare the AEPEM-GF composite electrolyte membrane, small circular pieces of glass fiber paper (radius of 0.65 cm) were soaked in the reactive solution (1 μL) so that the polymer precursor goes in between the fibers of glass fiber paper. Then further the soaked glass fiber paper is subjected to UV irradiation for 15-20 mins to obtain a composite membrane in dry chloride form. The dry membrane is then soaked in 6 M KOH solution for 24 to 28 hrs to give AEPEM-GF composite electrolyte membranes doped with OH group in the matrix.

Further, the through-plane conductivity studies of the AEPEM-GF composite electrolyte membranes were done at different temperatures. The conductivity of the prepared samples was measured by the same procedure as for the AEPEM membrane by using EIS. The conductivity measurements were carried out between 20° C. to 60° C. at every 10° C. interval. The temperature was controlled by using an environmental test chamber. The conductivity of the composite membrane at 30° C. was observed to be 9.0×10-2 S cm-1, which is superior to the optimized AEPEM based on the optimized reactive solution of AHM 70:30. All these results suggest that the prepared AEPEM-GF composite electrolyte membrane can be used as an anion conducting quasi-solid-state electrolyte for the fabrication of flexible ZABs. The significance of the in-situ polymerization technique in improving the electrode|electrolyte interfacial contact in ZABs is also proved.

In an embodiment the process of in-situ polymerization comprises of following steps;
a. taking approximately 10 μL of prepared AHM 70:30 reactive solution;
b. brush coating the above solution over the Pt/C or Pt/C-RuO₂ air-cathode to obtain a uniform coating followed by UV polymerization to obtain an AHM skin; and
c. contacting the above coated Pt/C or Pt/C-RuO₂ air-cathode with alkaline 6 M KOH to obtain AHM skin over the cathode surface which gets converted into an AEPEM ionic skin when in contact with alkaline 6 M KOH electrolyte.

The AEPEM-GF composite electrolyte membrane prepared in accordance with above embodiment in combination with the in-situ polymerization technique ensures better contact at triple-phase boundary thus, reinstating the plateau feature in the discharge plot (FIG. 13). Further, when using the AEPEM-GF composite membrane, the specific capacity of the AEPEM-GF ZAB with in-situ cell is improved to 483 mAh/g compared to AEPEM ZAB without in-situ cell (483 mAh/g).

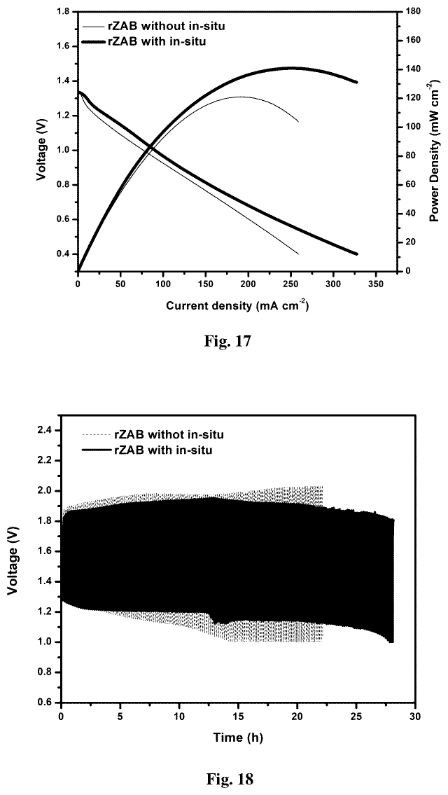

In further embodiment of the present invention a rechargeable zinc-air battery (rZAB) was demonstrated with the developed AEPEM-GF polymer electrolyte membrane using Pt/C-RuO₂ catalyst-coated GDL or carbon cloth substrate as the air-cathode, with and without in-situ polymerization approach. The system with in-situ polymerized cathode (rZAB with in situ) exhibited a superior peak power density of 140 mW cm-1 at the current density of 248 mA cm⁻² in comparison to a peak power density of 120 mW cm-2 at 190 mA cm-2 exhibited by zinc-air battery without in-situ polymerized cathode (rZAB without in situ). The rZAB with in situ also exhibited long-time charge discharging of 28 h without a significant increase in overpotential (FIG. 17, FIG. 18).

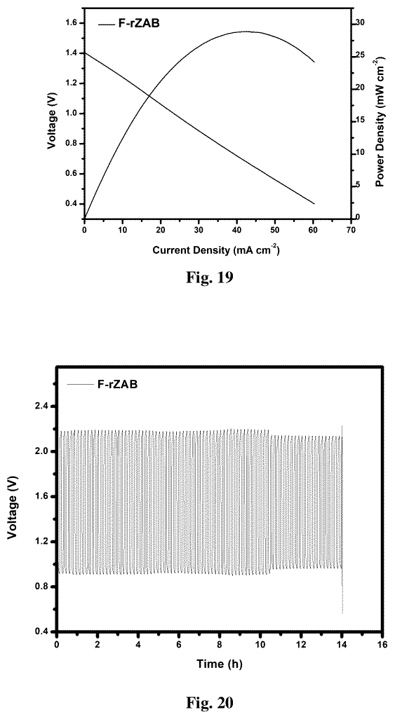

In one more embodiment of the present invention, a flexible rechargeable zinc-air battery (F-rZAB)) system of (2×4 cm² area) was fabricated and demonstrated. Thin Zinc foil of 0.1 mm thickness was used as anode. A catalyst coated over carbon cloth with a thin layer of in-situ polymerised ionic-skin was used as the air-cathode. The prepared AEPEM-GF membrane was sandwiched between the polymer-coated carbon cloth and Zinc foil to form a flexible and rechargeable zinc air battery (F-rZAB). The system exhibited an open circuit voltage (OCV) of around 1.35 V. Further from the linear sweep voltammetry (LSV) plots the cell exhibited a peak power density of 29 mW cm⁻² (FIG. 19). Further long-time charge discharge of the system was also done at a current density of 2 mA cm⁻² and the system run for 14 hours without significant increase in the overpotential (FIG. 20).

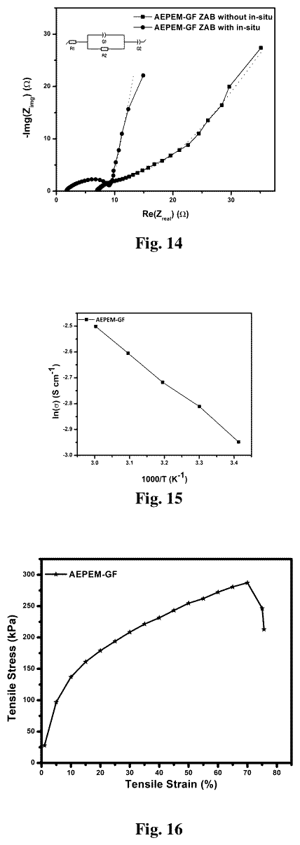

Further, EIS analysis was conducted to monitor the effect of using AEPEM-GF composite membranes to replace the simple AEPEM membranes. From EIS results, it is clear that an enhancement in the interfacial contact when AEPEM-GF composite electrolyte membrane is used along with the in-situ technique (AEPEM-GF ZAB with in-situ), which is apparent from the shift in the equivalent series resistance (ESR) as well as the charge transfer resistance values further to the left (FIG. 14).

In a nutshell, the present invention relates to anion Conducting Polymer Electrolyte Membranes prepared by Ultraviolet-Light Curing for Quasi-Solid-State Zinc-Air Batteries. In the present invention, the inventors have done the fabrication of a polymer-based electrolyte reinforced with glass fiber paper showing high ionic conductivity (9.0×10⁻² S cm⁻¹), high electrolyte uptake and retention properties and enhanced mechanical strength for application as a solid-state electrolyte in rechargeable zinc-air batteries. The use of glass fiber paper ensures inducing porosity in the polymer matrix along with enhanced electrolyte uptake. Further, an in-situ polymerisation of the precursor solution over the air-cathode was adopted to enhance the contact at the triple phase boundary, which is usually compromised while moving from a liquid to solid/quasi-solid-electrolytes. Furthermore, quasi-solid-state Zn-air batteries using the prepared AEPEM-GF polymer electrolytes have been analysed. Finally, a flexible quasi-solid-state zinc-air battery system using the prepared polymer electrolyte membrane in combination with in-situ polymerisation approach was fabricated and performance demonstrated.

Overall, the present invention deals with zinc-air battery fabrication by clubbing the process of preparing an OH⁻ ion conducting polymer electrolyte membrane and a photo-assisted free-radical polymerization for electrode|electrolyte interface enhancement.

### EXAMPLES

### Example 1: Conductivity Test

Through-plane conductivity studies of AEPEM membranes prepared from precursor solutions mentioned in Table 1 having different compositions were measured at different temperatures. The conductivity of the prepared samples can be measured by electrochemical impedance spectroscopy (EIS). The conductivity cells were fabricated in CR2032 coin cells by keeping the desired membranes having a radius of 0.65 cm and thickness around 0.045 cm in between two stainless steel plates of 1 mm thickness. The conductivity measurements were carried out between 20° C. to 60° C. at every 10° C. interval. The temperature was controlled by using an environmental test chamber.

The ln (σ) vs. temperature plot is presented in FIG. 5. The conductivity of AEPEM based on AHM 90:10 at 30° C. was observed to be 8.5×10⁻² S cm⁻¹ while that of AHM 70:30 and AHM 50:50 was 3.25×10⁻² S cm⁻¹ and 9.87×10⁻³ S cm⁻¹ respectively.

Further, the AEPEM-GF composite membrane exhibited a superior ionic conductivity of 9.0×10⁻² S cm⁻¹ at 30° C.

### Example 2

### Swelling Studies

Solvent uptake of the polymer membranes prepared from the AHM precursor solutions (Table 1) (polymer membranes prepared from the AHM precursor solution in the dry form (OH⁻ free) may be called AHM polymer membranes) and AEPEM-GF dry membrane under investigation were measured by weight method. In this method, the as-prepared dry polymer membranes (AHM polymer membrane) were immersed in 6 M KOH solution and weighed in the intervals of 2 hr for 24 hrs. The solvent uptake of the AHM polymer membranes was calculated according to the Equation 1:

$$Solvent uptake \% = ( ( {w}_{wet} - {w}_{dry} ) / {w}_{dry} ) \times 100 \qquad Equation 1$$

W_{wet} and W_{dry} are wet and dry weight of polymer membranes. Mean solvent uptake was obtained as the average of two samples to reduce errors.

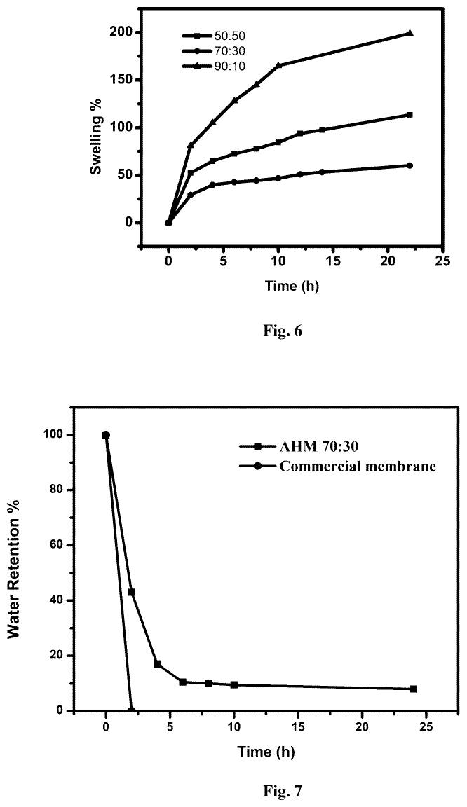

From FIG. 6, we can observe that polymer membrane based on AHM 90:10 has superior solvent intake property compared to the others. But the mechanical stability of these AHM 90:10 membranes is lost after swelling in 6 M KOH solution for 24 hrs. This loss in mechanical stability annihilates the advantages of AHM 90:10 despite its good conductivity and solvent uptake. Therefore, AHM 70:30 is taken for further studies considering its potential as a better replacement for aqueous electrolyte due to its enhanced mechanical stability and decent ionic conductivity. The AEPEM-GF composite membrane had an enhanced electrolyte uptake in comparison to all other AHM counterparts.

### Example 3

### Electrolyte Retention Studies

Electrolyte retention studies of the AEPEM membrane based on AHM 70:30 and AEPEM-GF membranes were done by weight method at 25° C. and weighed at an interval of 2 hr for 24 hrs, and compared with conventionally used commercial membranes treated with 6 M KOH solution. From FIG. 7, it can be seen that AHM 70:30 polymer membrane possesses superior water retention properties than commercial membranes which in turn become completely dry after 2 hrs.

### Example 4

### Mechanical Strength Studies

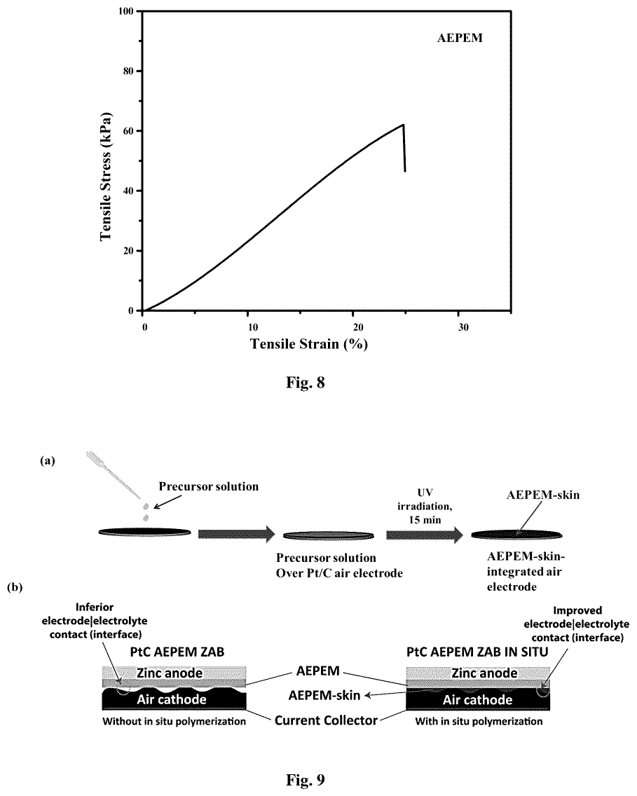

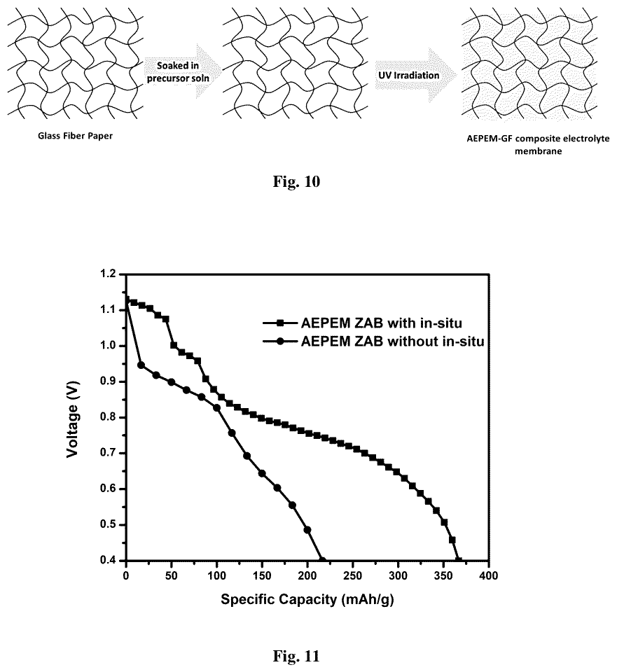

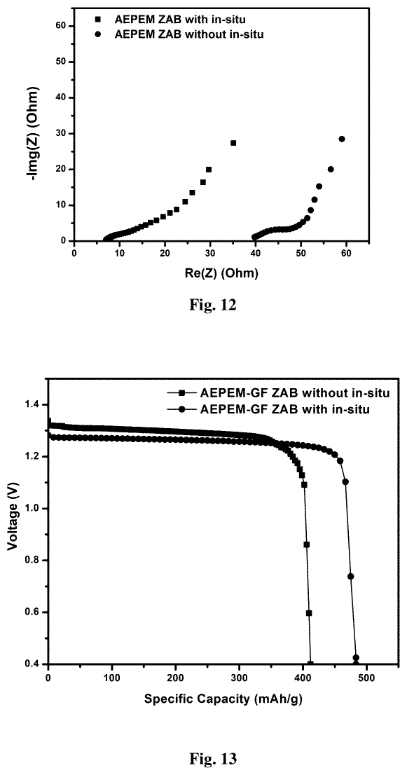

Further tensile strength studies of the optimized AEPEM based on AHM 70:30 precursor solution was performed (FIG. 8). The Obtained stress-strain plot shows that the prepared membrane showed a decent stretchability up to 23-28% and it possesses tensile stress of about 60-65 KPa while the AEPEM-GF membrane showed a superior stretchability up to 68 to 70% and a tensile stress of about 280 to 290 kPa (refer FIG. 16). Thus, from the above data, we can conclude that the prepared membrane possesses decent mechanical stability even under high stress.

### Example 5: Process of Preparation

A reactive solution (also called as precursor solution) is prepared which consist of 2 (Acryloyloxy) ethyl] trimethylammonium chloride solution (AOETMA), Hydroxy ethyl methacrylate (HEMA), Polyethylene glycol methyl ether methacrylate (PEGMEMA), and Polyethylene glycol diacrylate (PEGDA) as the monomers, which contribute to mechanically stable polymer electrolyte membranes on UV-curing. Further, 2-Hydroxy-2-methylpropiophenone (HMPP) is used as the photo-initiator and added in said reactive solution in the desired ratio, and thereafter are casted between two Mylar Films and on subjecting to UV-curing for 15 mins undergoes cross-linking polymerization to give polymer electrolyte membranes with solid-like operability and dimensional stability. Stable membranes of varying composition were obtained by changing the concentration of monomers and fixing the composition of cross linker and initiator at 1 wt %. The membranes thus obtained are in the chloride form (Cl⁻) and dry form. For zinc-air battery applications, the membrane must be converted into OH⁻ form by treating it with 6 M KOH solution for 24 hrs.

### Advantages of the Invention

Simple process employed to make the membrane.
Raw materials are easily available.
Polymer matrix itself contributes to the ionic conductivity through quaternary ammonium groups.
Improving electrode|electrolyte contact through in-situ polymerization.

1. A process for preparing an anion exchange polymer electrolyte membrane, comprising the steps of:
a) preparing a reactive solution comprising a 2-[(Acryloyloxy) ethyl] trimethylammonium chloride solution (AOETMA), a hydroxy ethyl methacrylate (HEMA), a poly (ethylene glycol) methyl ether methacrylate (PEGMEMA), and a acrylate/methacrylate monomer/oligomer crosslinker;
b) adding a 2-Hydroxy-2-methylpropiophenone or free-radical polymerization initiator in the reaction solution of step a) as a photo-initiator;
c) optionally soaking a glass fiber paper (GF) in the reactive solution of step b);
d) casting the reactive solution of step b) or placing GF soaked in reactive solution of step c) between two polyethylene terephthalate films e) subjecting the above-casted films to a UV-curing to give a cationic (or positively charged) polymer electrolyte membrane (AHM) or cationic (or positively charged) glass fiber polymer electrolyte membrane (AHM-GF); and
f) treating polymer electrolyte membrane of step f) with KOH solution to form a OH⁻ doped anion exchange polymer electrolyte membranes (AEPEMs) or OH⁻ doped glass fiber anion exchange polymer electrolyte membrane (AEPEM-GF);
wherein, at least one of the monomer is having a quaternary ammonium salt.

2. The process as claimed in claim 1, wherein the reactive solution comprises 2-(Acryloyloxy) ethyl] trimethylammonium chloride solution (AOETMA), hydroxy ethyl methacrylate (HEMA), poly (ethylene glycol) methyl ether methacrylate (PEGMEMA), and poly (ethylene glycol) diacrylate (PEGDA).

3. The process as claimed in claim 2, wherein the reactive solution comprises 1 to 1.8 wt % of 2-(Acryloyloxy) ethyl] trimethylammonium chloride solution (AOETMA), 4 to 7.2 wt % of hydroxy ethyl methacrylate (HEMA), 1 to 5 wt % poly (ethylene glycol) methyl ether methacrylate (PEGMEMA), and 1 wt % poly (ethylene glycol) diacrylate (PEGDA).

4. The process as claimed in claim 1, wherein the reactive solution comprises 1.2 to 1.6 wt % 2-(Acryloyloxy) ethyl] trimethylammonium chloride solution (AOETMA), 5.4 to 5.8 wt % hydroxy ethyl methacrylate (HEMA), 2.8 to 3.2 wt % poly (ethylene glycol) methyl ether methacrylate (PEGMEMA), and 1 wt % poly (ethylene glycol) diacrylate (PEGDA).

5. The process as claimed in claim 1, wherein the monomer/oligomer as disclosed in step a) is a poly (ethylene glycol) based monomer or oligomer.

6. The process as claimed in claim 1, wherein all steps a) to f) including optional step c) are done at temperature in the range of 20° C.-30° C., and without the need of solvent.

7. A battery comprising an anion exchange polymer electrolyte membrane as claimed in claim 1.

8. A zinc-air battery comprising:
a) a Pt/C or Pt/C-RuO₂ air cathode or in-situ polymerized Pt/C or Pt/C-RuO₂ air cathode based on GDL or carbon cloth substrate;
b) an anion exchange polymer electrolyte membrane (AEPEM) or glass fiber anion exchange polymer electrolyte membrane (AEPEM-GFs) as claimed in claim 1;
c) a zinc anode; and
d) a metallic casing.

9. The zinc-air battery as claimed in claim 8, wherein the metallic casing comprises a base, a spacer, and a spring in a coin-cell configuration.

10. The zinc-air battery as claimed in claim 8, wherein the membrane shows a stretchability of up to 68 to 70% and tensile stress ranging in about 280 to 290 kPa.

11. The zinc-air battery as claimed in claim 8, wherein the in-situ polymerized Pt/C-RuO₂ air cathode is prepared by steps comprising of;
a) brush coating the reactive solution comprising a 2-[(Acryloyloxy) ethyl] trimethylammonium chloride solution (AOETMA), a hydroxy ethyl methacrylate (HEMA), a poly (ethylene glycol) methyl ether methacrylate (PEGMEMA), and a acrylate/methacrylate monomer/oligomer crosslinker;
b) subjecting the polymer-coated air cathode to UV polymerization to obtain AHM skin over the cathode surface; and
c) contacting the polymer skin with KOH solution from the AEPEM-GF membrane while device fabrication, subsequently turning the AHM skin to the AEPEM-skin or AEPEM-GF skin.

12. The zinc-air battery as claimed in claim 8, wherein the AEPEM-GF composite electrolyte membrane in combination with the in-situ polymerized Pt/C or Pt/C-RuO₂ air-cathode improves an electrode-electrolyte contact in Zinc-air batteries.

13. A zinc-air battery as claimed in claim 8, wherein the zinc-air battery comprises:
a) an anode made up of thin Zinc foil of 0.1 mm thickness;
b) cathode having a Pt/C or Pt/C-RuO₂ coated over GDL or carbon cloth substrate with a thin layer of in-situ polymerized polymer skin from precursor solution comprising a 2-[(Acryloyloxy) ethyl] trimethylammonium chloride solution (AOETMA), a hydroxy ethyl methacrylate (HEMA), a poly (ethylene glycol) methyl ether methacrylate (PEGMEMA), and a acrylate/methacrylate monomer/oligomer crosslinker; and
c) an AEPEM or AEPEM-GF membrane as the quasi-solid-state electrolyte;
wherein the AEPEM or AEPEM-GF membrane is sandwiched between the catalyst-coated carbon cloth or GDL substrate and Zinc foil.
